(19) United States
(12) Patent Application Publication
(10) Pub. No.: US 2022/0277202 A1
(43) Pub. Date: Sep. 1, 2022

(54) MOVEMENT PREDICTION DEVICE, MOVEMENT PREDICTION METHOD, AND MOVEMENT PREDICTION PROGRAM

(71) Applicant: NIPPON TELEGRAPH AND TELEPHONE CORPORATION, Tokyo (JP)

(72) Inventors: Masamichi HOSODA, Tokyo (JP); Maiko NAYA, Tokyo (JP); Akira NAKAYAMA, Tokyo (JP); Masaru MIYAMOTO, Tokyo (JP)

(73) Assignee: NIPPON TELEGRAPH AND TELEPHONE CORPORATION, Tokyo (JP)

(21) Appl. No.: 17/637,848

(22) PCT Filed: Aug. 27, 2019
(86) PCT No.: PCT/JP2019/033519

§ 371 Date: Feb. 24, 2022

(51) Int. Cl. G06N 5/02

(52) U.S. Cl. CPC G06N 5/02

(57) ABSTRACT

The movement of an agent can be simulated with high accuracy using the attributes of the agent. A population density for each of mobile agents is calculated based on an area of a section from its position to a set front length and a size magnification of the other agent existing in the section. A moving speed of the mobile agent for each of the mobile agents is calculated based on a free walking speed of agent information, a calculated population density, and a predetermined parameter.

### TECHNICAL FIELD

The disclosed technique relates to a movement predicting device, a movement predicting method, and a movement predicting program.

### BACKGROUND ART

A method of predicting the movement of many people by a simulation is conventionally known.

For example, a method of obtaining a moving speed of each agent is known (see NPL 1).

### CITATION LIST

### Non Patent Literature

NPL 1: Junji Innan, Takayoshi Masagaki, Fumihiko Kake, Kiyoshi Fukui, and Takeshi Yamada. Examination of measures for evacuation guidance information around large-scale terminal stations using congestion simulation methods. Civil Engineering Planning Research and Lectures, Vol. 45, June 2012.

### SUMMARY OF THE INVENTION

### Technical Problem

However, there is a problem that the prediction accuracy is not sufficient because the conditions unique to each agent cannot be considered.

An object of the disclosure is to provide a movement predicting device, a movement predicting method, and a movement predicting program capable of simulating the movement of an agent with high accuracy using the attributes of the agent.

### Means for Solving the Problem

A first aspect of the disclosure is a movement predicting device including: an agent generating unit configured to receive, as an input, edge information on each edge indicating a path connecting each of nodes and agent information having a departure time, a departure point in each node, a destination point in each node, a free walking speed of an agent, and a size magnification for the agent determined for each of a plurality of the agents and record each mobile agent departing from the departure point in accordance with the departure time of the agent information; an edge selecting unit configured to select an edge on which the mobile agent moves for each of the mobile agents based on a position of the agent, the destination point of the agent information, and the edge information; a front density calculating unit configured to calculate a population density for each of the mobile agents based on an area of a section from the position of the mobile agent to a predetermined front length and the size magnification of the other agent in the section; a moving speed calculating unit configured to calculate a moving speed of the mobile agent for each of the mobile agents based on the free walking speed of the agent information, the calculated population density, and a predetermined parameter; a position updating unit configured to update the position of the mobile agent for each of the mobile agents based on the calculated moving speed; and a determination unit configured to repeat a simulation by each of the operations of the agent generating unit, the edge selecting unit, the front density calculating unit, the moving speed calculating unit, and the position updating unit until a predetermined condition is satisfied.

A second aspect of the disclosure is a movement predicting method at a computer including: receiving edge information on each edge indicating a path connecting each of nodes and agent information having a departure time, a departure point in each node, a destination point in each node, a free walking speed of an agent, and a size magnification for the agent determined for each of a plurality of the agents; recording each mobile agent departing from the departure point in accordance with the departure time of the agent information; selecting an edge on which the mobile agent moves for each of the mobile agents based on a position of the agent, the destination point of the agent information, and the edge information; calculating a population density for each of the mobile agents based on an area of a section from the position of the mobile agent to a predetermined front length and the size magnification of the other agent in the section; calculating a moving speed of the mobile agent for each of the mobile agents based on the free walking speed of the agent information, the calculated population density, and a predetermined parameter; updating the position of the mobile agent for each of the mobile agents based on the calculated moving speed; and repeating a simulation by each of the operations until a predetermined condition is satisfied.

A third aspect of the disclosure is a movement predicting program for causing a computer to perform: receiving edge information on each edge indicating a path connecting each of nodes and agent information having a departure time, a departure point in each node, a destination point in each node, a free walking speed of an agent, and a size magnification for the agent determined for each of a plurality of the agents; recording each mobile agent departing from the departure point in accordance with the departure time of the agent information; selecting an edge on which the mobile agent moves for each of the mobile agents based on a position of the agent, the destination point of the agent information, and the edge information; calculating a population density for each of the mobile agents based on an area of a section from the position of the mobile agent to a predetermined front length and the size magnification of the other agent in the section; calculating a moving speed of the mobile agent for each of the mobile agents based on the free walking speed of the agent information, the calculated population density, and a predetermined parameter, updating the position of the mobile agent for each of the mobile agents based on the calculated moving speed; and repeating a simulation by each of the operations until a predetermined condition is satisfied.

### Effects of the Invention

According to the disclosed technique, the movement of the agent can be simulated with high accuracy using the attributes of the agent.

### BRIEF DESCRIPTION OF DRAWINGS

FIG. 1 is a block diagram illustrating a configuration of a movement predicting device according to this embodiment.

FIG. 2 is a block diagram illustrating a hardware configuration of the movement predicting device.

FIG. 3 is a flowchart illustrating a flow of a movement prediction process performed by the movement predicting device.

### DESCRIPTION OF EMBODIMENTS

Hereinafter, an example of an embodiment of the disclosed technique will be described with reference to the drawings. Note that the same reference numerals are given to the same or equivalent components and parts in each drawing. Further, the dimensional ratios in the drawings are exaggerated for convenience of description and may differ from the actual ratios.

First, the background of the present disclosure and the underlying technique will be described and then the outline of the present disclosure will be described.

Because many people gather at large-scale events, people may not move smoothly to a destination point in congested places. In such a situation, a dangerous situation leading to an accident may occur. As countermeasures for this issue, the place and time of congestion, proper guidance for alleviating the congestion, the assumption of troubles and countermeasures, and the like are examined in a preliminary examination. At this time, a simulation of the movement of many people is performed using a people flow simulator in order to confirm how the people flow (hereinafter referred to as people flow).

There are several types of people flow simulators. For example, there is a multi-agent simulation (hereinafter referred to as MAS) in which each pedestrian is used as an agent. Among these, there is a method of reproducing the physical shapes of passages and intersections in detail on a simulator and performing simulation with a detailed physical model in which various characteristics are given to each agent. However, there is a problem that a large amount of calculation and a large memory capacity are required to perform the simulation and the simulation takes time. On the other hand, there is a method of reproducing a passage network with a simple model in which a passage is an edge and a passage branching and merging location is a node (hereinafter referred to as a node edge model) (see NPL 1). In this method, the amount of calculation is reduced by using a simple speed model for the behavior of the agent and hence a high-speed simulation is performed.

In NPL 1, each agent determines its own moving speed vᵢ [m/s] by the following formula (1).

$$\begin{matrix}[ Math . 1 ] & \\ {v}_{i} = \{ \begin{matrix}{V}_{i} & ( 0 \leq ρ \leq {ρ}_{i} ) \\ 1.8 {ρ}^{- 1} - 0.3 & ( {ρ}_{i} \leq ρ \leq 6. ) \\ 0 & ( ρ \geq 6. )\end{matrix} & ( 1 )\end{matrix}$$

Here, p is the population density [people/m²] in front L [m] of the agent. When the width in front L [m] of the agent is W [m] and the number of people (the number of other agents) therein is n [people], the population density p is the following formula (2).

$$\begin{matrix}[ Math . 2 ] & \\ ρ = \frac{n}{L \times W} & ( 2 )\end{matrix}$$

The front L is one setting as a whole and the width W is the width of the edge on which the agent is present.

ρᵢ is the density satisfying Vᵢ=1.8ρᵢ⁻¹−0.3 and is the density determined by the agent individually based on the free walking speed v₁. In NPL 1, L is set to 6 m and W is set for each edge.

From the above, a situation is reproduced in which each agent moves at an individually set free walking speed Vᵢ (maximum speed) when the front is vacant, moves while decreasing a walking speed in accordance with the density when the front starts to be congested, and stops at a certain level or more of congestion.

Further, it is possible to perform a simulation in which the free walking speed Vᵢ individually set for each agent is changed or these are mixed because human attributes such as age and presence or absence of land knowledge are reflected in the agents. Further, it is also possible to perform a simulation in which the ratio and distribution of mixed attributes are changed.

More than anything else, in the method of NPL 1, the parameter which can be set for each agent is only the free walking speed Vᵢ. Accordingly, it is possible to perform a simulation by individually setting the maximum speed of each agent. However, the “size” of each agent is not considered because the calculation is performed using the population density. For example, a space will be congested with a smaller number of people and a speed will stop because a person moving in a wheelchair occupies a larger area than a person walking normally.

However, an area occupied by the wheelchair cannot be reflected in the calculation of the population density. Further, a small child occupies a smaller area than an adult, but the area occupied by the small child likewise cannot be reflected in the calculation of the population density. It is difficult to simulate such a state in which people of different sizes, such as wheelchairs and small children, coexist. Further, it is difficult to perform a simulation in which the ratio and distribution of these mixtures are changed.

If a simulation is based on a detailed model that is not anode edge model, there is no problem regarding the size of the agent, but there is a problem that a simulation takes time.

Here, in this embodiment, in the node edge model, a size magnification sᵢ of the agent is added as agent information and the density is calculated in consideration of the size magnification sᵢ.

Hereinafter, a configuration of this embodiment will be described.

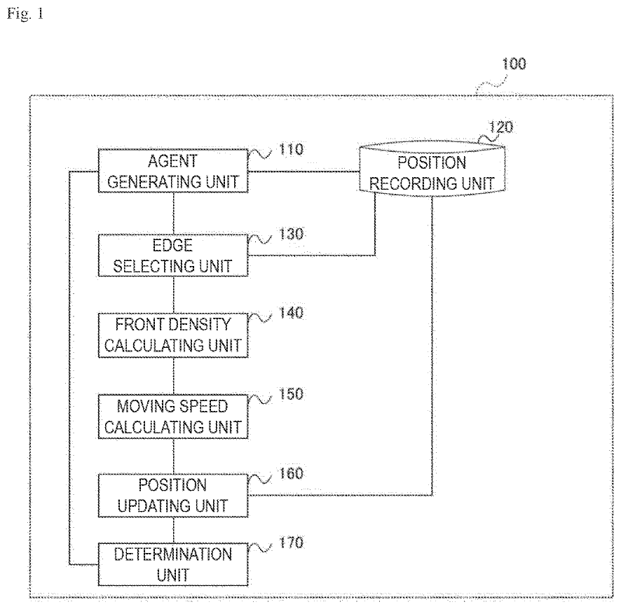

FIG. 1 is a block diagram illustrating a configuration of a movement predicting device of this embodiment.

As illustrated in FIG. 1, a movement predicting device 100 includes an agent generating unit 110, a position recording unit 120, an edge selecting unit 130, a front density calculating unit 140, a moving speed calculating unit 150, a position updating unit 160, and a determination unit 170.

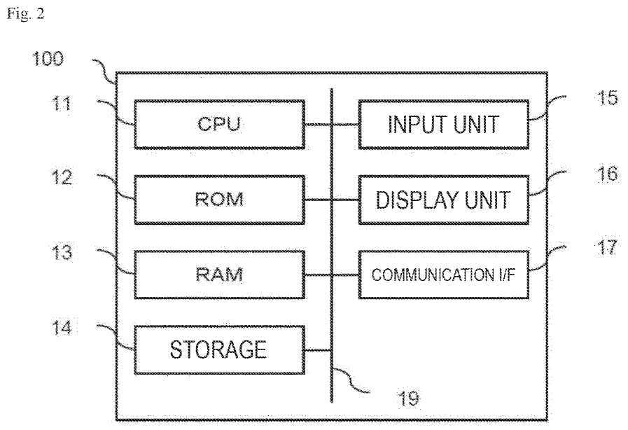

FIG. 2 is a block diagram illustrating a hardware configuration of the movement predicting device 100.

As illustrated in FIG. 2, the movement predicting device 100 includes a central processing unit (CPU) 11, a read only memory (ROM) 12, a random access memory (RAM) 13, a storage 14, an input unit 15, a display unit 16, and a communication interface (I/F) 17. Each configuration is connected to communicate with each other via a bus 19.

The CPU 11 is a central processing unit and is configured to execute various programs or control each component. That is, the CPU 1I reads a program from the ROM 12 or the storage 14 and executes the program using the RAM 13 as a work area. The CPU 11 controls each configuration and performs various calculation operations according to the program stored in the ROM 12 or the storage 14. In this embodiment, the ROM 12 or the storage 14 stores a movement predicting program.

The ROM 12 stores various programs and various data. The RAM 13 which is a work area temporarily stores the program or data. The storage 14 is configured as a hard disk drive (HDD) or a solid state drive (SSD) and stores various programs including an operating system and various data.

The input unit 15 includes a pointing device such as a mouse and a keyboard and is used to perform various inputs.

The display unit 16 is, for example, a liquid crystal display and displays various types of information. The display unit 16 may adopt a touch panel type and may function as the input unit 15.

The communication interface 17 is an interface for communicating with other devices such as a terminal and, for example, standards such as Ethernet (trade name), FDDI, and Wi-Fi (trade name) are used.

Next, each functional configuration of the movement predicting device 100 will be described. Each functional configuration is realized by the CPU 11 reading the movement predicting program stored in the ROM 12 or the storage 14 and executing the program by expanding the program in the RAM 13.

The movement predicting device 100 receives agent information and edge information as an input.

In the agent information, agent numbers i (serial numbers of i=1, 2, 3, . . . , m) are given to all agents (all pedestrians). As the agent information, a departure time, a node number of a departure point, a node number of a destination point, a free walking speed Vᵢ, and a size magnification sᵢ are set for each agent. The departure point is a departure point in each node. The destination point is a destination point in each node. The agent information can be set so that a plurality of agent groups having different distributions of the free walking speed vᵢ and the size magnification sᵢ are mixed at an arbitrary ratio in accordance with the attributes of the pedestrians.

The edge information is information relating to each of the edges for which a starting node number, an ending node number, an edge length, an edge width W, and speed coefficient parameters α, β, and γ are set. Two pieces of edge information connecting the same nodes may be prepared in different directions to accelerate calculation. The edge connecting nodes Nos. 1 and 2 include two pieces of edge information, that is, edge information which is “starting node No. 1 and ending node No. 2” and edge information which is “starting node No. 2 and ending node No. 1.” The former uses the agent going from node No. 1 to node No. 2 and the latter uses the agent going from node No. 2 to node No. 1.

The movement predicting device 100 performs a simulation by using the agent generating unit 110, the edge selecting unit 130, the front density calculating unit 140, the moving speed calculating unit 150, and the position updating unit 160 as a simulator. The movement predicting device 100 starts a simulation after storing in the position recording unit 120 that all agents have not departed before the execution of the simulation. Then, the movement predicting device 100 repeats a process of performing a calculation of t=0 for each time, for example, in seconds and performing a calculation of t=1 one second later when the previous calculation is completed. If a simulation for j seconds is performed when the execution time is j, the movement predicting device 100 completes the simulation when the calculation of t=j is completed. Hereinafter, each component of the movement predicting device 100 will be described. Hereinafter, an operation at t=k will be described as an operation performed for each time.

The agent generating unit 110 records each mobile agent departing from the departure point in accordance with the departure time of the agent information in the position recording unit 120. Hereinafter, the agent that moves recorded in the position recording unit 120 is referred to as a mobile agent. Hereinafter, an operation example of the agent generating unit 110 will be described.

The agent generating unit 110 first searches for the agent whose departure time is k among all agents in the agent information. The agent generating unit 110 records the agent number, the position information, and the agent departure state of the agent at the time t=k in the position recording unit 120 by the search. With this recording, the mobile agent can be tracked. The position information is a combination of the “last passed node number,” the “next node number that will be passed.” and the “distance from the last passed node”. That is, at the time of departure, the position information is recorded such that the “last passed node number” is the departure point node number of the agent information, the “next node number that will be passed” is not determined, and the “distance from the last passed node” is 0. This position information is recorded for each time by a simulation. The “last passed node number” is the position of the mobile agent referred to in the process of the edge selecting unit 130.

The edge selecting unit 130 selects an edge on which the mobile agent moves for each of the mobile agents based on the position of the mobile agent, the destination point of the agent information, and the edge information. Hereinafter, an operation example of the edge selecting unit 130 will be described.

The edge selecting unit 130 first acquires the position information of all walking mobile agents (that have departed and not arrived) from the position recording unit 120. When the “next node number that will be passed” is not determined, that is, the edge to go to next is not selected in the acquired position information, the edge selecting unit 130 searches for the edge connected to that node by referring to the edge information and selects a desired edge to go to among them. The edge selecting unit 130 stores the ending node number in the edge information of the selected edge in the “next node number that will be passed” of the position information. The selection method is arbitrary, but, for example, the edge selecting unit 130 finds and selects the edge to reach at a distance closest to the destination point. Further, the edge selecting unit 130 may randomly select the edges so that the probability of selecting the edge closer to the destination point becomes higher or randomly select the edges so that the probability of selecting any edge is the same.

The front density calculating unit 140 calculates a population density p for each of the mobile agents. In the calculation of the population density p, the front density calculating unit 140 first obtains the area of the section with respect to the front length L and the width W of the edge where the mobile agent is present. The front length L is a front length which is set in advance from the position of the mobile agent. The front density calculating unit 140 calculates the population density p based on the obtained area of the section and the size magnification sᵢ of the other agent in the section from the position of the mobile agent to the front distance L [m]. The front length L is set to, for example, 6 m. Hereinafter, an operation example of the front density calculating unit 140 will be described.

The front density calculating unit 140 first obtains the area of the section from the position of the mobile agent to the front distance L [m] and calculates the population density p for each mobile agent based on the obtained area of the section. The population density calculated here is not population density p calculated by formula (2), but is the population density calculated in consideration of the size of each agent. In this calculation, the front density calculating unit 140 uses the size magnification sᵢ individually set for each agent. This is sᵢ=1.0 for an ordinary pedestrian. The size magnification is set to be larger than 1.0 when the occupied area is larger than that of the ordinary pedestrian as in a wheelchair. For example, the size magnification sᵢ is 1.5 when the occupied area is 1.5 times and the size magnification sᵢ is 2.0 when the occupied area is 2.0 times. In contrast, when the occupied area is smaller than that of the ordinary pedestrian as in a child, the size magnification is set to be smaller than 1.0. For example, the size magnification sᵢ is set to 0.75 when the occupied area is 0.75 times and the size magnification sᵢ is set to 0.5 when the occupied area is 0.5 times. In this way, the size magnification sᵢ is set in accordance with the attributes of the agent. The front density calculating unit 140 calculates the population density p by the following formula (3) using the size magnification sᵢ set in this way.

$$\begin{matrix}[ Math . 3 ] & \\ ρ = \frac{{\sum }_{k = 1}^{n} {s}_{k}}{L \times W} & ( 3 )\end{matrix}$$

n is the number of other agents in the section from the position of the mobile agent to the front distance L [m] and the value set for each of the other agents is used as the size magnification sᵢ. The denominator L×W of the formula (3) is the area of the section. This formula (3) has an increased calculation amount as compared with the formula (2), but the increase amount is very small, and the calculation amount and the memory consumption are small compared with a simulation having a detailed physical model.

When the distance from the position of the mobile agent to the edge end point is shorter than L [m], a range to the edge end point may be a section for calculating the population density. Further, when another edge is connected to the node of the edge end point, the population density may be calculated by obtaining the area of the section straddling the edge including any edge of the connection destination.

A calculation example of the population density will be described. It is assumed that there is an edge with a length of 25 in and a width W of 2 m. It is assumed that there are five mobile agents A to E on the edge. Each of the positions is set as below. Agent A is located at a position of 10 m from the edge start point. Agent B is located at a position of 14 m from the edge start point. Agent C is located at a position of 15 in from the edge start point. Agent D is located at a position of 19 m from the edge start point. Agent E is located at a position of 22 m from the edge start point.

In this case, when L is set to 6 [m], two agents B and C located in a range extending from the agent A itself located at 10 m to 16 m and separated from the agent A forward by 6 m, that is, a range from 10 n to 16 in, are calculation targets in the calculation of the population density of the agent A. The agent A itself is not included in the calculation target and the agents D and E who are ahead of the front length 6 in are not included in the calculation target.

The area used in the calculation of the population density of the agent A becomes L×W=6×2=12 [m²] and in the conventional calculation method based only on the number of people, the population density can be calculated as Number of People/Area=2/12=0.167 [people/m²].

Further, in the calculation of the population density of the agent B, two agents C and D located in a range from the agent B itself located at 14 m to 20 m separated from the agent B by 6 m, that is, a range from 14 m to 20 m, are calculation targets. The agent A behind the agent B, the agent B itself, and the agent E ahead of 6 in are not included in the calculation target. The above is the calculation example of the population density.

The moving speed calculating unit 150 calculates the moving speed of the mobile agent for each of the mobile agents. The moving speed calculating unit 150 calculates the moving speed of the mobile agent based on the free walking speed V; of the agent information, the population density p calculated by the front density calculating unit 140, and the speed coefficient parameter. Hereinafter, an operation example of the moving speed calculating unit 150 will be described.

The moving speed calculating unit 150 calculates the moving speed vᵢ of the mobile agent for each mobile agent. This calculation may be the same as the formula (0) or may be rewritten as the following formula (4).

[Math. 4]

vᵢ=γmax(0,min(Vᵢ,αβ⁻¹−β)) (4)

max and min of the formula (4) are defined as below.

$$max ( x , y ) = \{ \begin{matrix}x & ( x > y ) \\ y & ( x < y )\end{matrix} \\ min ( x , y ) = \{ \begin{matrix}x & ( x < y ) \\ y & ( x > y )\end{matrix}$$

The speed coefficient parameters α, β, and γ are speed constants set in the edge information of the selected edge and are the same as the formula (1), for example, in the case of α=1.8, β=0.3, and γ=1.0. In NPL 1, fixed values common to all edges are simply used as the parameters α, β, and γ. On the other hand, in this embodiment, the parameters α, β, and γ are set to be changeable in accordance with the attributes for each edge. For example, α is set to a large value in order to reproduce a situation that the speed decreases rapidly and stops even if the population density is low because an umbrella is held in a rainy day. As α becomes larger, a speed decrease rate in accordance with an increase in the population density increases. Further, after the speed decrease rate is determined by α, β is determined according to the population density at which the movement is desired to be stopped. For example, even on a rainy day, the same α and β as in fine weather may be used on an edge with a roof such as an underpass or an arcade. Further, γ is used to be decreased according to changes in darkness at night. γ is adjusted so as not to decrease much at bright edges even at night. Therefore, α, β, and γ are set for each edge. Further, in order to reproduce the sunset over time during the simulation, the sudden rain due to the weather change, and the like, α, β, and γ of each edge may be changed depending on the time. In this way, in the moving speed calculating unit 150, the parameters α, β, and γ are set to be adjusted in accordance with the attributes for each edge changing in accordance with the time.

The position updating unit 160 updates the position of the mobile agent of the position recording unit 120 for each of the mobile agents based on the moving speed calculated in the moving speed calculating unit 150. Hereinafter, an operation example of the position updating unit 160 will be described.

The position updating unit 160 calculates the position information at t=k+1 for each of the mobile agents by using the position information at t=k stored in the position recording unit 120 and the moving speed vᵢ calculated by the moving speed calculating unit 150. Then, the position updating unit 160 records the agent number and the position information at the time t=k+1 for each of the mobile agents in the position recording unit 120. When there is a mobile agent that has reached the destination point, the position updating unit 160 records that the mobile agent has reached.

The determination unit 170 repeats a simulation using the operations of the agent generating unit 110, the edge selecting unit 130, the front density calculating unit 140, the moving speed calculating unit 150, and the position updating unit 160 until a predetermined condition is satisfied. In the determination unit 170, when the update of the position information for all mobile agents is completed, the operation at t=k is completed and the operation at the next time is performed by incrementing the time.

These operations are repeated. The determination unit 170 ends a simulation when the time has reached the execution time j.

The movement predicting device 100 reads the simulation result of each of the mobile agents from the position recording unit 120 and outputs the simulation result. The simulation results output position information for each agent i=1, 2, 3, . . . , m at each time t=0, 2, 3, . . . of each mobile agent.

Next, an operation of the movement predicting device 100 will be described.

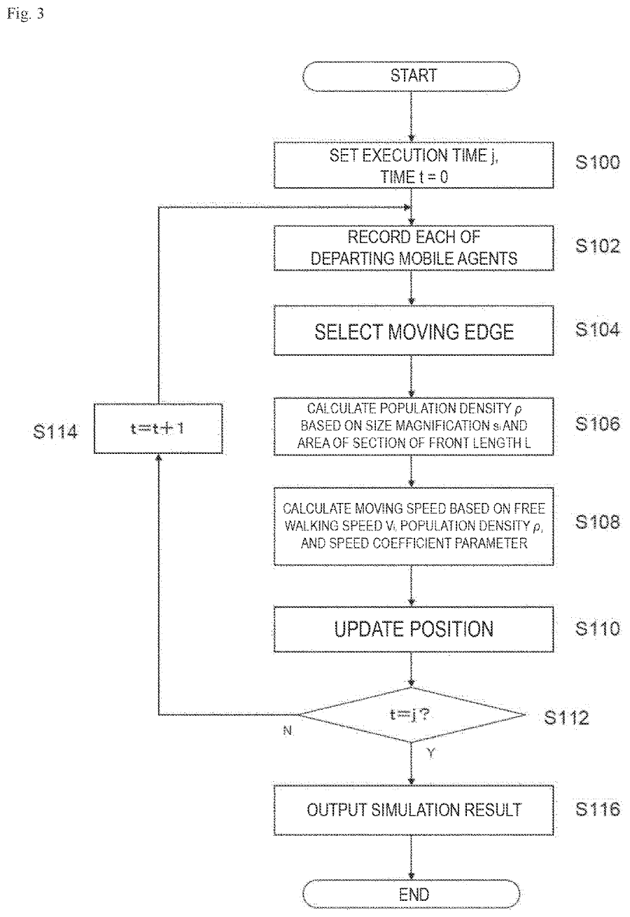

FIG. 3 is a flowchart illustrating a flow of a movement predicting process using the movement predicting device 100. The movement predicting process is performed in such a manner that the CPU 11 reads the movement predicting program from the ROM 12 or the storage 14 and expands the program in the RAM 13 to execute the program. The movement predicting device 100 receives the edge information and the agent information as an input and performs the following process.

In step S100, the CPU 11 sets the simulation execution time j and sets the time t=0.

In step S102, the CPU 11 records each of the mobile agents departing from the departure point in accordance with the departure time of the agent information in the position recording unit 120. Here, the agent with t=k becomes the mobile agent with the departure time of the agent information as k.

In step S104, the CPU 11 selects an edge on which the mobile agent moves for each of the mobile agents based on the position of the mobile agent, the destination point of the agent information, and the edge information.

In step S106, the CPU 11 calculates the population density p for each of the mobile agents. The population density p is calculated according to the formula (3) based on the area of the section obtained for the front length L from the position of the mobile agent and the width W of the edge where the mobile agent exists and the size magnification sᵢ of the other agent existing in the section.

In step S108, the CPU 11 calculates the moving speed of the mobile agent for each of the mobile agents. The moving speed of the mobile agent is calculated according to the formula (4) based on the free walking speed Vᵢ of the agent information, the population density p calculated by the front density calculating unit 140, and the speed coefficient parameter. The speed coefficient parameters are α, β, and γ and are adjusted in accordance with the attributes for each edge changing in accordance with the time.

In step S110, the CPU 11 updates the position of the mobile agent of the position recording unit 120 for each of the mobile agents based on the moving speed calculated in step S108.

In step S112, the CPU 11 determines whether t is j and proceeds to step S116 when t is j or proceeds to step S114 when t is not j.

In step S114, the CPU 11 increments t=t+1 and proceeds to step S102 to repeat the process.

In step S116, the CPU 11 reads the simulation result of each of the mobile agents from the position recording unit 120, outputs the simulation result, and ends the process.

As described above, the movement predicting device 100 of this embodiment can simulate the movement of the agent with high accuracy using the size of the attributes of the agent.

While taking advantage of the simple and high-speed characteristics of the node edge model, it is possible to perform a simulation that takes into account the “size” of each agent. For example, it is possible to reproduce that the space will be congested with a smaller number of people and the speed will stop because a people moving in a wheelchair occupies a larger area than a people walking normally. Further, the area occupied by small children is narrower than that of adults and this influence can be reproduced.

It is possible to perform a simulation in a state in which people of different sizes, such as wheelchairs and small children, coexist and to perform a simulation in which the mixing ratio and distribution are changed.

Further, if a simulation is based on a detailed physical model that is not anode edge model, a simulation can be performed in consideration of the “size”, but the method of this embodiment has a merit that a simulation can be performed with a smaller calculation amount and a faster and lower memory than the simulation that is not the node edge model.

Note that the movement predicting process which is performed by causing the CPU to read and execute the software (program) in the above-described embodiments may be performed by various processors other than the CPU. Examples of the processor in such a case include a programmable logic device (PLD) such as a field-programmable gate array (FPGA) of which circuit configuration can be changed after manufacturing, a dedicated electric circuit such as an application specific integrated circuit (ASIC) that is a processor having a circuit configuration designed dedicatedly for executing specific processing, and the like. Further, the movement predicting process may be performed by one of these various processors or a combination of two or more processors of the same type or different types (for example, a combination of a plurality of FPGAs and a combination of a CPU and an FPGA). More specifically, the hardware structure of such various processors is an electrical circuit acquired by combining circuit devices such as semiconductor devices.

Further, in the above-described embodiments, a form in which the movement predicting program is stored (installed) in the storage 14 in advance has been described, but the disclosure is not limited thereto. The program may be provided in the form of being stored in a non-transitory medium such as a compact disk read only memory (CD-ROM), a digital versatile disk online memory (DVD-ROM), and a universal serial bus (USB) memory. Further, the program may be downloaded from an external device via a network.

Regarding the above embodiments, the following appendixes will be further disclosed.

### Appendix 1

A movement predicting device including:
a memory; and
at least one processor connected to the memory,
wherein the processor is configured to:
receive edge information on each edge indicating a path connecting each of nodes and agent information having a departure time, a departure point in each node, a destination point in each node, a free walking speed of an agent, and a size magnification of the agent determined for each of a plurality of the agents,
record each mobile agent departing from the departure point in accordance with the departure time of the agent information,
select an edge on which the mobile agent moves for each of the mobile agents based on a position of the agent, the destination point of the agent information, and the edge information, calculate a population density for each of the mobile agents based on an area of a section from the existing position of the mobile agent to a predetermined front length and the size magnification of the other agent existing in the section,
calculate a moving speed of the mobile agent for each of the mobile agents based on the free walking speed of the agent information, the calculated population density, and a predetermined parameter.
update the position of the mobile agent for each of the mobile agents based on the calculated moving speed, and
repeat a simulation by each of the operations until a predetermined condition is satisfied.

### Appendix 2

A non-transitory storage medium for storing a movement predicting program causing a computer to perform:
receiving edge information on each edge indicating a path connecting each of nodes and agent information having a departure time, a departure point in each node, a destination point in each node, a free walking speed of an agent, and a size magnification of the agent determined for each of a plurality of the agents,
recording each mobile agent departing from the departure point in accordance with the departure time of the agent information,
selecting an edge on which the mobile agent moves for each of the mobile agents based on a position of the agent, the destination point of the agent information, and the edge information, calculating a population density for each of the mobile agents based on an area of a section from the existing position of the mobile agent to a predetermined front length and the size magnification of the other agent existing in the section,
calculating a moving speed of the mobile agent for each of the mobile agents based on the free walking speed of the agent information, the calculated population density, and a predetermined parameter,
updating the position of the mobile agent for each of the mobile agents based on the calculated moving speed, and
repeating a simulation by each of the operations until a predetermined condition is satisfied.

### REFERENCE SIGNS LIST

100 Movement predicting device
110 Agent generating unit
120 Position recording unit
130 Edge selecting unit
140 Front density calculating unit
150 Moving speed calculating unit
160 Position updating unit
160 Position updating unit
170 Determination unit

1. A movement predicting device
including:
a memory; and
at least one processor connected to the memory, wherein the at least one processor is configured to:
receive, as an input, edge information on each edge indicating a path connecting each of nodes and agent information having a departure time, a departure point in each node, a destination point in each node, a free walking speed of an agent, and a size magnification for the agent determined for each of a plurality of the agents and record each mobile agent departing from the departure point in accordance with the departure time of the agent information;
select an edge on which the mobile agent moves for each of the mobile agents based on a position of the agent, the destination point of the agent information, and the edge information;
calculate a population density for each of the mobile agents based on an area of a section from the position of the mobile agent to a predetermined front length and the size magnification of the other agent in the section;
calculate a moving speed of the mobile agent for each of the mobile agents based on the free walking speed of the agent information, the calculated population density, and a predetermined parameter;
update the position of the mobile agent for each of the mobile agents based on the calculated moving speed; and
repeat a simulation by each of the operations until a predetermined condition is satisfied.

2. The movement predicting device according to claim 1,
wherein the size magnification is determined in accordance with attributes of the agent, and
wherein the parameter is adjusted in accordance with the attributes for each edge changing in accordance with a time.

3. A computer-implemented movement predicting method including:
receiving edge information on each edge indicating a path connecting each of nodes and agent information having a departure time, a departure point in each node, a destination point in each node, a free walking speed of an agent, and a size magnification for the agent determined for each of a plurality of the agents;
recording each mobile agent departing from the departure point in accordance with the departure time of the agent information;
selecting an edge on which the mobile agent moves for each of the mobile agents based on a position of the agent, the destination point of the agent information, and the edge information;
calculating a population density for each of the mobile agents based on an area of a section from the position of the mobile agent to a predetermined front length and the size magnification of the other agent in the section;
calculating a moving speed of the mobile agent for each of the mobile agents based on the free walking speed of the agent information, the calculated population density, and a predetermined parameter;
updating the position of the mobile agent for each of the mobile agents based on the calculated moving speed; and
repeating a simulation by each of the operations until a predetermined condition is satisfied.

4. The computer-implemented movement predicting method according to claim 3,
wherein the size magnification is determined in accordance with attributes of the agent, and
wherein the parameter is adjusted in accordance with the attributes for each edge changing in accordance with a time.

5. A non-transitory storage medium for storing a movement predicting program for causing a computer to perform:
receiving edge information on each edge indicating a path connecting each of nodes and agent information having a departure time, a departure point in each node, a destination point in each node, a free walking speed of an agent, and a size magnification for the agent determined for each of a plurality of the agents;
recording each mobile agent departing from the departure point in accordance with the departure time of the agent information;
selecting an edge on which the mobile agent moves for each of the mobile agents based on a position of the agent, the destination point of the agent information, and the edge information;
calculating a population density for each of the mobile agents based on an area of a section from the position of the mobile agent to a predetermined front length and the size magnification of the other agent in the section;
calculating a moving speed of the mobile agent for each of the mobile agents based on the free walking speed of the agent information, the calculated population density, and a predetermined parameter;
updating the position of the mobile agent for each of the mobile agents based on the calculated moving speed; and
repeating a simulation by each of the operations until a predetermined condition is satisfied.
